(19) United States
(12) Patent Application Publication
(10) Pub. No.: US 2012/0112462 A1
(43) Pub. Date: May 10, 2012

(54) Wave Energy Converter

(76) Inventors: Robert Bado, Delray Beach, FL (US); Artem Madatov, Dnieprodzerzhinsk (UA)

(21) Appl. No.: 13/283,917

(22) Filed: Oct. 28, 2011

Related U.S. Application Data
(60) Provisional application No. 61/412,175, filed on Nov. 10, 2010.

(51) Int. Cl. F03B 13/20

(52) U.S. Cl. 290/53

(57) ABSTRACT

Apparatus for converting the energy of ocean waves into electricity, comprises a buoyant body that floats on the surface of water and a submerged body suspended from the buoyant body by flexible cables at a depth where water is still. The submerged body comprises electric generators and horizontally-aligned rotors with a plurality of variable geometry, preferably flexible, buckets attached to a lateral surface of each rotor. The buckets are so shaped to move through water with minimum resistance in one direction and with maximum resistance in the opposite direction. The buoyant body rises with each wave, dragging the submerged body upward through the region of still water until a wave reaches its crest. As a wave falls, the gravity drags the submerged body downward until a wave reaches its trough. This movement causes unidirectional rotation of rotors. This rotation is transmitted to electric generators.

### CROSS-REFERENCE TO RELATED APPLICATIONS

This U.S. patent application claims the priority filing date of U.S. Provisional Application No. 61/412,175 filed on Nov. 10, 2010, of the same title and in the name of inventors in common with the present application.

### STATEMENT REGARDING FEDERALLY SPONSORED RESEARCH AND DEVELOPMENT

Not Applicable

### REFERENCE TO SEQUENCE LISTING

Not Applicable

### BACKGROUND OF INVENTION

This invention relates to a device for converting the energy of water waves into a usable form of energy, e.g. electricity.

Global demand for electric power is expected to increase from 14.8 trillion kilowatt hours in 2003 to 30.1 trillion kilowatt hours by 2030, according to the Energy Information Administration.

In 2008, the USA produced over 3 trillion kWh of electricity, 70 percent of it (2 trillion kWh) from fossil fuels, a majority of that came from coal. The resulting emission is estimated to be 2 billion tons of CO2, 15 million tons of SO2 and 6 million tons of NOx.

The current energy mix must undergo fundamental revisions in order to preserve our way of life. Currently approximately 80% of the world's energy consumption is based on coal, petroleum and natural gas, which contain fossil carbon.

Environmental damage and increasing energy demand, causing the depletion of fossil fuels and thus the rise in costs, are contributing to the increasing development of renewable energy systems that capture energy from renewable natural resources, including ocean waves, hydro, wind and sunlight, and convert it into electricity.

Every continent on the planet is surrounded by a cleaner, safer, more efficient answer to our energy needs. The ocean holds a tremendous amount of untapped energy.

Ocean energy comes in a variety of forms such as marine currents, tidal currents, geothermal vents, and waves. Wave energy is generally considered to be the most concentrated and least variable form of renewable energy. Waves are predictable days and even months in advance making it easy to match supply and demand.

As water is approximately 800 times denser than air, the energy density of waves vastly exceeds that of wind, dramatically increasing the amount of energy available for harvesting.

The World Energy Council has estimated that approximately 2 Terawatts (2 million megawatts), about double current world electricity production, could be produced from the ocean waves.

There are currently several approaches, in different stages of development, for capturing wave energy and converting it into electricity. Methods for generating electricity from wave energy can be divided into two general categories: onshore systems and offshore systems.

Onshore systems are located at the edge of the shore, often on a sea cliff or a breakwater, and typically must concentrate the wave energy first before using it to drive an electrical generator. As waves approach the shore, the energy in the waves decreases; therefore, onshore wave power stations do not take full advantage of the amount of energy that waves in deeper water produce. In addition, there are a limited number of suitable sites for onshore systems and there are environmental and possible aesthetic issues with these wave power stations due to their size and location on the seashore.

Offshore systems are typically located from several hundred yards (meters) to several miles (kilometers) offshore. The wave energy conversion system can be located above, on or below the ocean surface.

One of the well-known technologies for harnessing the kinetic energy of water relies upon a water wheel system. Long used in water streams to generate power, those systems were placed in a continuous current. The water driven by the current pushes against the vanes or buckets installed around the perimeter of the wheel. This force causes the wheel to turn.

Many attempts have been made to harness the energy of water waves by water-wheel devices by positioning them directly into the path of the surface waves.

Adapting water wheel technology to the oceans has proven difficult for a variety of reasons. First, the braking of the ocean waves can swamp the water wheel therefore applying equal force to vanes or buckets on opposite sides of the wheel. No force imbalance is created, so the water wheel does not spin. Second, known systems ordinarily make no provision for utilizing both the kinetic and potential energy of the waves. Further, many of these technologies only work in relatively high waves, making the systems impractical for many areas with low or inconsistent wave heights. Finally, the water wheel, as well as any other energy harnessing device installed at the ocean or sea surface is exposed to destructive forces of nature.

The present invention addresses the above stated issues, as well as other problems related to wave energy conversion, and provides a system that efficiently extracts energy from a wide range of ocean wave heights at a low cost, and is capable of withstanding the most powerful storms.

### SUMMARY OF INVENTION

Apparatus and method for converting the energy of sea and ocean waves into a usable form of energy, for example electrical energy or mechanical energy.

In accordance with the present invention, the apparatus comprises two bodies flexibly attached to each other. The first one of which, is a moored to the seabed buoyant body. Suspended from the buoyant body by vertical suspender cables, chains, ropes or other flexible lines, is a fully submerged second body comprises an electric generator or a group of generators, and a horizontally-aligned modular, preferably foldable frame rotor or a group of such interconnected rotors with a plurality of variable geometry buckets, preferably, made out of a flexible or otherwise elastic material, attached to a lateral surface of each rotor.

The submerged body is held at a depth where the water is not affected by the waves, therefore is still or relatively still. Preferably, the submerged body is held at a depth of around one-half wavelength of the prevailing waves in the region.

The present invention is based on the fact that water waves have only a finite depth. No matter how significant is a wave action on the water surface, at the same time the water at a certain depth is calm. The motion of water beneath the surface decreases exponentially with depth.

The present invention utilizes the water resistance (drag) that opposes the relative motion of the submerged body through the water. Drag forces act in a direction opposite to the oncoming flow velocity.

The buoyant body rises with each wave dragging the flexibly attached submerged body upward through the region of stationary water until a wave reaches its crest. As a wave falls, the gravity drags the said submerged body downward through the region of stationary water until a wave reaches its trough. The suspender cables, chains, ropes or other flexible lines are under constant tension due to multiple opposing forces i.e. buoyancy, gravity, drag.

This up and down motion through a region of stationary water causes rotation of the rotor or a group of interconnected rotors with attached variable geometry buckets that are so shaped to move through the water with minimum resistance in one direction and with maximum resistance in the opposite direction. The plurality of rotors are interconnected through a gear or another rotation transferring system. Two adjacent rotors in the group are so designed to rotate in opposite directions.

This rotation of the rotor or a group of interconnected rotors is transmitted, through a gear or another rotation transferring system, to an electric generator or a group of such generators installed on the submerged body. The said generator is equipped with a flywheel and an overrunning clutch, ensuring its smooth and consistent rotation.

Each variable geometry bucket is preferably pocket-shaped, and thus is open on one side and closed on all others. Each variable geometry bucket is so shaped to provide maximum resistance to the oncoming relative water flow at its open end, and minimum resistance at its closed end.

Preferably, this variable geometry buckets are made out of a flexible or otherwise elastic material. The said buckets include or might include a rigid material.

The plurality of said buckets are attached to a lateral surface of the rotor and are preferably evenly distributed around the rotor from end to end. All buckets attached to the rotor are open in the same direction. As a result, the rotor will always turn in the same direction, regardless of the direction of the movement to which it is subjected by the movements of the buoyant body under the influence of the passing waves.

Each rotor has a modular, preferably foldable frame thus improving transportability and reducing transport cost. The lateral surface of the rotor is fabricated either as a single element preferably made out of a flexible or otherwise elastic material and securely attached to the said frame, or, alternatively, as a plurality of flexible, semi-flexible or rigid surface elements that are securely attached to the frame.

The buoyant body, which is moored to the seabed, is so designed and shaped to provide minimum resistance to the passing waves. The buoyant body is preferably of modular design, and comprises a plurality of smaller buoyant bodies attached to each other, thus improving survivability, transportability and reducing transport cost.

Other systems, objects, methods, features and advantages of the invention will be, or will become, apparent upon examination of the following figures and detailed description. It is intended that all such additional systems, objects, methods, features and advantages be included within this description and this summary, be within the scope of the invention, and be protected by the following claims.

### BRIEF DESCRIPTION OF DRAWINGS

The invention can be better understood with reference to the following drawings and description. The components in the figures are not necessarily to scale. Emphasis instead being placed upon illustrating the principles of the invention.

FIG. 1 shows water particle motion in a water wave. The orbital motion of water particles decreases rapidly with increasing depth below the surface.

FIG. 2 is a schematic drawing of the apparatus in operation, moving upward.

FIG. 3 is a schematic drawing of the apparatus in operation, moving downward.

FIG. 4 is a schematic perspective view of a rotor.

### DETAILED DESCRIPTION OF INVENTION

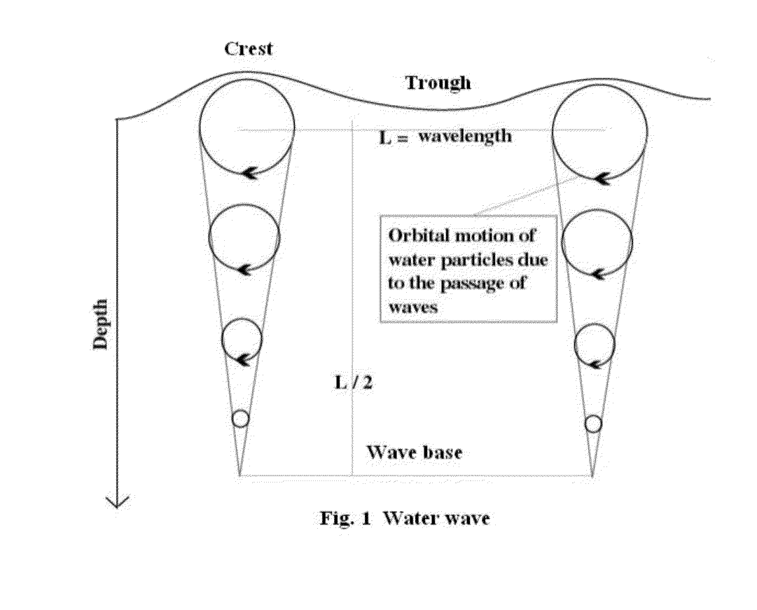

The motion of water beneath the surface decreases exponentially with depth. Water waves have only a finite depth. No matter how significant is a wave action on the water surface, at the same time the water at a certain depth is calm. In general, the wave power below sea level decays exponentially by −2πd/L where d is the depth below sea level, and L is a wavelength. This property is valid for waves in water with depths greater than L/2. FIG. 1 shows the wave-induced water particle motion in deep water, where the water depth d to wavelength L ratio is grater than 0.5.

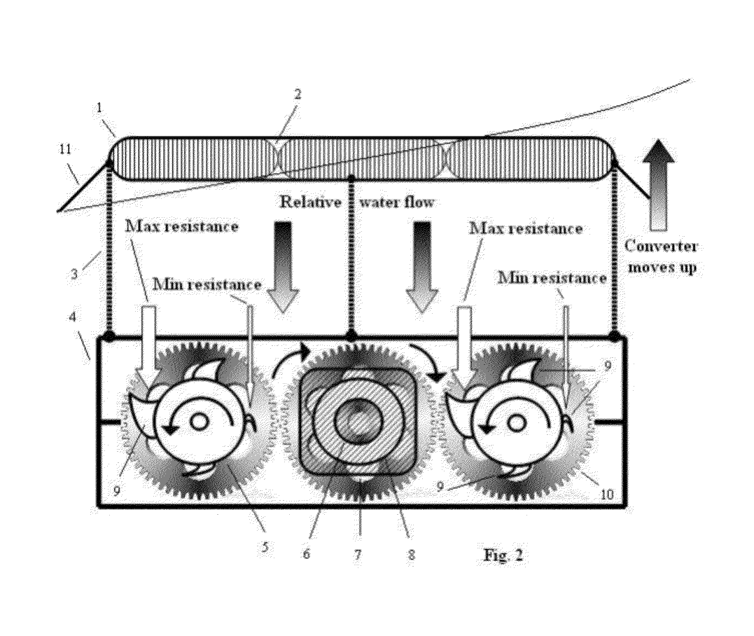

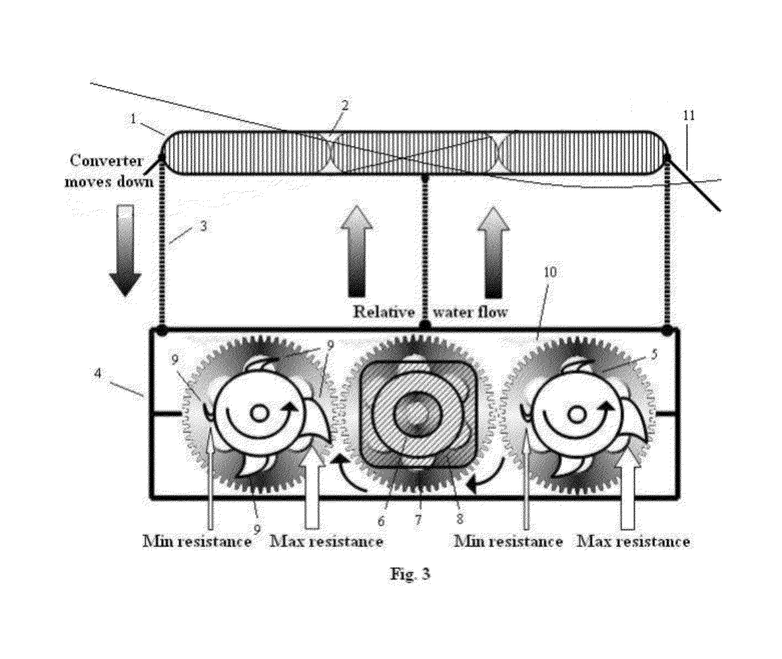

In FIG. 2 and FIG. 3, a wave energy conversion apparatus in accordance with the invention is shown in operation. In accordance with the present invention, the apparatus comprises two bodies flexibly attached to each other. The first one of which, is a moored to the seabed buoyant body 1. Suspended from the buoyant body 1 by vertical suspender cables (chains, ropes or other flexible lines) 3, is a fully submerged second body 4 comprises an electric generator 7 or a group of generators, and a horizontally-aligned modular, preferably foldable frame rotor 5 or a group of such interconnected rotors with a plurality of variable geometry buckets 9, preferably, made out of a flexible or otherwise elastic material, attached to a lateral surface of each rotor 5.

The buoyant body 1, which is moored to the seabed by mooring cables 11, is so designed and shaped to provide minimum resistance to the passing waves. The buoyant body 1 is preferably of modular design, and comprises a plurality of smaller buoyant bodies 2 attached to each other, thus improving survivability, transportability and reducing transport cost.

The generator 7 is equipped with a flywheel 8 and an overrunning clutch 6, ensuring smooth and consistent rotation of the generator 7.

The said rotor 5 or a group of rotors are interconnected to each other and the said generator 7 or a group of generators through a gear 10 or another rotation transferring system.

In order to fully utilize the energy of passing sea or ocean waves, the submerged body 4 is held at a depth where the water is not affected by the waves, therefore is still or relatively still. Preferably, the submerged body 4 is held at a depth of around one-half wavelength of the prevailing waves in the region.

As a wave rises FIG. 2, the buoyant body 1 moves upward, dragging the flexibly attached submerged body 4 upward through the region of stationary water until the wave reaches its crest. The suspender cables (chains, ropes or other flexible lines) 3 are under constant tension due to multiple opposing forces i.e. buoyancy, gravity, drag.

The water resistance (drag) opposes the relative motion of the submerged body 4 with the installed rotor 5, or a group of such rotors, through the water. Drag forces act in a direction opposite to the oncoming flow velocity.

Each rotor 5 has a plurality of variable geometry buckets 9 attached to its lateral surface and are preferably evenly distributed around the rotor 5 from end to end.

Each variable geometry bucket 9 is preferably pocket-shaped, and thus is open on one side and closed on all others. Each variable geometry bucket 9 is so shaped to provide maximum resistance to the oncoming relative water flow at its open end, and minimum resistance at its closed end.

Preferably, this variable geometry bucket 9 is made out of a flexible or otherwise elastic material. The said bucket 9 includes or might include a rigid material.

All buckets 9 attached to the rotor 5 are open in the same direction. As a result, the rotor 5 will always turn in the same direction, regardless of the direction of the movement to which it is subjected by the movements of the buoyant body 1 under the influence of the passing waves.

This motion of the submerged body 4 through a region of stationary water causes rotation of the rotor 5 or a group of interconnected rotors. Thus, with the buckets 9 arranged as in FIG. 2, it will be evident that, as the rotor 5 moves upward through relatively calm water, the buckets 9 on the left side of the rotor 5 will open, and therefore offer greater resistance to the relative flow of water than the closed buckets 9 on the right side of the rotor 5. Drag coefficient of the closed bucket 9, that is shaped as a streamlined half-body, is around 0.09. Drag coefficient of the open bucket 9, that is approximately shaped as a hollow half-sphere, is around 2.0. Due to a significant difference in drag forces applied to the open and closed buckets 9 on opposite sides of the rotor 5, it will result in a counterclockwise rotation of the rotor 5. Two adjacent rotors 5 in the group are so designed to rotate in opposite directions, clockwise and counterclockwise.

As a wave falls FIG. 3, the buoyant body 1 moves downward, the flexibly attached submerged body 4 is dragged downward through the region of stationary water by the force of gravity until the wave reaches its trough. However, then the buckets 9 on the right side of the rotor 5 will open, thus offering greater resistance to the relative water flow, than those closed buckets 9 on the left side of the rotor 5. So the rotor 5 will continue rotating counterclockwise.

This continuous unidirectional rotation of the rotor 5 with the attached variable geometry buckets 9 is transmitted, by a gear 10, which, in the illustrated embodiment FIG. 2 and FIG. 3, interconnects a group of rotors and the electric generator 7, and converted into another usable form of energy, e.g. electricity. Two adjacent gear wheels 10 rotate in opposite directions, clockwise and counterclockwise.

Electrical power from the generator 7 is transmitted either to a shore, or to an offshore platform, or to some equipment installed on the apparatus.

Alternatively, the said rotation of the rotors 5 through the gear 10 could drive a pump or compressor or any other energy converting device.

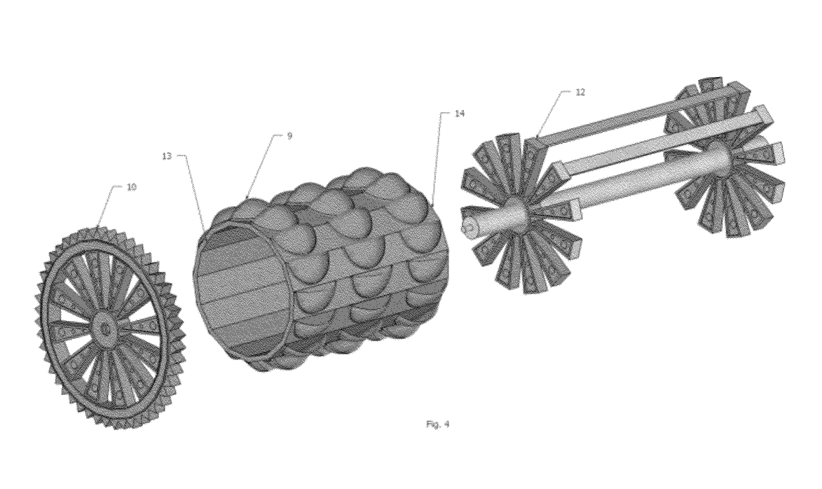

FIG. 4 shows schematic perspective view of the rotor 5. Each rotor 5 is built on a modular, preferably foldable frame 12 thus improving deployment and transportability, reducing the rotor's weight and associated costs. The lateral surface 13 of the rotor 5 is preferably fabricated as a single element made out of a flexible or otherwise elastic material that is securely attached to the frame 12.

Alternatively, the said lateral surface 13 consists of a plurality of flexible, semi-flexible or rigid surface elements 14 securely attached to the frame 12, as shown in FIG. 4.

The variable geometry buckets 9 are preferably fabricated as an integral part of the lateral surface elements 13 and 14. Alternatively, the said buckets 9 can be securely attached to the said elements 13 and 14.

The preceding detailed description is not intended to be limited to the specific embodiments set forth herein, but on the contrary, the description is intended to be exemplary, and it will be apparent to those of ordinary skill in the art that many more embodiments and implementations are possible that are within the scope of the invention. Accordingly, the invention is not to be restricted except in light of the attached claims and their equivalents. Also, various modifications and changes may be made within the scope of the following claims.

What is claimed is:

1. An apparatus for converting the energy of sea and ocean waves into a usable form of energy, for example electricity, comprising two bodies flexibly attached to each other. The first one of which, is a moored to the seabed buoyant body that floats on the surface of water. Suspended from the buoyant body by vertical suspender cables, chains, ropes or other flexible lines, is a fully submerged second body comprises an electric generator or a group of generators, and a horizontally-aligned rotor or a group of interconnected rotors with a plurality of variable geometry buckets attached to a lateral surface of each rotor.

2. An apparatus according to claim 1, wherein the said two bodies are flexibly attached to each other via suspender cables, chains, ropes or other flexible lines.

3. An apparatus according to claim 1, wherein the submerged body is suspended from the said buoyant body and held at a depth where the water is not affected by the waves, therefore is still or relatively still.

4. An apparatus according to claim 1, wherein the said submerged body comprises an electric generator or a group of generators, and a horizontally-aligned rotor or a group of interconnected rotors.

5. An apparatus according to claims 1 and 4, wherein the said rotor or a group of rotors are interconnected to each other and a generator or a group of generators through a gear or another rotation transferring system.

6. An apparatus according to claims 1 and 4, wherein the said generator is equipped with a flywheel and an overrunning clutch.

7. An apparatus according to claims 1 and 4, wherein each rotor is provided with a plurality of variable geometry buckets, preferably, made out of a flexible or otherwise elastic material, attached to a lateral surface of each rotor, and are, preferably, evenly distributed around the rotor from end to end.

8. An apparatus according to claims 1 and 7, wherein the said variable geometry buckets are preferably pocket-shaped, and thus are open on one side and closed on all others.

9. An apparatus according to claims 1, 7 and 8, wherein the said variable geometry buckets attached to the rotor, are open in the same direction.

10. An apparatus according to claim 1, wherein the buoyant body is preferably of modular design, and comprises a plurality of smaller buoyant bodies attached to each other.

11. An apparatus according to claims 1 and 4, wherein each rotor has a modular, preferably foldable frame.

12. An apparatus according to claims 1 and 4, wherein the lateral surface of the rotor is fabricated either as a single element preferably made out of a flexible or otherwise elastic material and securely attached to the said frame, or, alternatively, as a plurality of flexible, semi-flexible or rigid surface elements that are securely attached to the frame.
